(19) United States
(12) Patent Application Publication
(10) Pub. No.: US 2022/0207945 A1
(43) Pub. Date: Jun. 30, 2022

(54) Machine or device lock enclosure

(71) Applicant: John Pal, JR., Petersburg, KY (US)

(72) Inventor: John Pal, JR., Petersburg, KY (US)

(21) Appl. No.: 16/974,321

(22) Filed: Dec. 29, 2020

(51) Int. Cl. G07C 9/30; E05B 47/00; G07C 9/29

(52) U.S. Cl. CPC G07C 9/30; E05B 47/0001; E05Y 2900/608; E05B 2047/0095; G07C 9/29

(57) ABSTRACT

A machine or device lock enclosure that can be integrated or a separate device for securing any machine or device including voting election machine or device or any other security purpose having adaptability to be used with any and all devices and machine or devices. The machine or device lock enclosure can also be used with an machine or device involved in the voting process including but not limited to ballot openers, poll books, optical scanners, tabulators, printers, electronic voting management systems, universal voting systems, folded ballot processing machine or devices, and voter registration management equipment. It will require two or more opposed observers, each with a unique way to open two or more locks, with a mechanical keys, keypads, combination locks, cards or cell phones, or by any other method to turn on the machine or device, or to turn on certain functions within any machine or device.

### BACKGROUND OF THE INVENTION

Historically the problem with fraud in elections has been not having two opposed party's observing the functions of many of the voting machine or devices. Most of the machine or devices can be turned on freely by the poll workers without any supervision or without two opposed parties observing the operation of the machine or device and fraud can occur. This present invention will solve this problem, in that you need two or more opposed observers, each with a unique way to open two or more locks, with a mechanical key, keypad, combination lock, card (including magnetic and all other types), or cell phone, remote controls (including but not limited to radio waves, sound waves, infrared waves, or any other type of wave) optical reader (any type including but not limited to optical readers and bar code readers)s, or by any other method to turn on the machine or device, or to turn on certain functions within any machine or device. This invention can also apply to any machine or device that is not involved with the voting process. This invention can be used in a multitude of situations not mentioned here.

### BRIEF SUMMARY OF THE INVENTION

Disputes of fraud in elections have haunted elections for many years with one party or the other secretly in the back room turning on voting machine or devices and adding ballots or ballot counts to the voting machine or device. This invention will overcome these weaknesses in our voting system by requiring two or more opposed parties to be present to turn on the machine or device or to turn on certain functions of the machine or device.

This voting machine or device lock enclosure can be built into any existing voting machine or device, or could be a separate component attached to an existing voting machine or device by any connection means, including but not limited to connectors, hardwired, cell phone, remote control (including but not limited to radio waves, sound waves, infrared or any type of wave), and optical reader (any type including but not limited to optical readers and bar code readers).

The voting machine or device lock enclosure consist of at least two locks and requires the possession of two unique means of opening each of the two locks. The most common form of opening a lock would be possession of two differently cut mechanical keys, a mechanical keypad, combination locks, cards that a card reader would read (including magnetic and all other types), or cell phones, remote controls (including but not limited to radio waves, sound waves, infrared or any type of wave), optical reader (any type including but not limited to optical readers and bar code readers)s, or by any other means to turn on the machine or device, or to turn on certain functions within the machine or device.

The voting machine or device lock enclosure can also consist of any type of connection, including but not limited to mechanical or electrical switch or connector or any combination, including but not limited to a solenoid (including magnetic), electronic switch (fet: field effect transistor, for example), waves (including but not limited to radio waves, sound waves, infrared waves or by any other type of wave), optical reader (any type including but not limited to optical readers and bar code readers)s, or by any combination or by any means that will open both the locks to complete or provide electric continuity to the same series circuit or different circuits in two places, thereby completing the circuit(s) when both locks are activated.

Within any voting machine or device or any machine or device, the circuit to be controlled could be any circuit. If control of disabling the power to the machine or device is desired, then the circuit disabled could be the supply voltage circuit. If the control of disabling a higher level function of the machine or device is desired, then the for example, the circuit supplying voltage to the cpu (central processing unit) could be disabled.

### BRIEF DESCRIPTION OF THE DRAWINGS

FIG. 1 sets forth a view in perspective of the machine or device lock enclosure as integrated into any voting machine or device or other machine or device with two mechanical locks. The two locks shown are installed into the container/cover (could be installed in many configurations) of any voting machine or device or other machine or device. The hinge is also shown. Once you unlock and open the cover there is a switch (could be configured with multiple switches). Internally the wires or by other means will be connected inside the voting machine or device or other machine or device.

FIG. 2 sets forth a view in perspective of the machine or device lock enclosure as integrated into any voting machine or device or other machine or device with two mechanical locks. The two locks shown are installed into the container/cover (could be installed in many configurations) of any voting machine or device or other machine or device. The hinge is also shown. Once you unlock and open the cover there is a button (could be configured with multiple buttons). Internally the wires or by other means will be connected inside the voting machine or device or other machine or device.

FIG. 3 sets forth a view in elevation of the machine or device lock enclosure as a separate component with two mechanical locks. Externally the wires would connect to the voting machine or device or other machine or device or by other means. Also displayed in a connector that will connect into the separate voting machine or device or other machine or device.

FIG. 4 sets forth a view in elevation of the machine or device lock enclosure as a separate component shown with a numerical key pad. Externally the wires would connect to the voting machine or device or other machine or device or by other means. Also displayed are wires without a connector because in this configuration the wires will be hard wired into the separate voting machine or device or other machine or device.

FIG. 5 sets forth a schematic of the machine or device lock enclosure with buttons (to turn on the machine or device or any process in the machine or device). The buttons (note: the schematic could be configured as a single button.) are shown and each are connected to its own contact or switch and when both switches are connected it will complete the series circuit. The series circuit can be connected to interrupt any process in any machine or device or voting machine or device and is shown by the square boxes which could be any process but are shown as source of process power and any process.

FIG. 6 sets forth a schematic of the machine or device lock enclosure with one switch (note: the schematic could be configured with multiple switches). The switch is shown connected to its own contact of switch and when connected it will complete the series circuit. The series circuit can be connected to interrupt any process in any machine or device or voting machine or device and is shown by the square boxes which could be any process but are shown as source of power and power supplied to machine or device.

FIG. 7 sets forth a view in elevation of the two mechanical keys required to successfully turn on the circuit of the machine or device lock enclosure. The two cards are also shown that are required to successfully open a card reader to successfully turn on the circuit of the machine or device lock enclosure (not shown in drawings). There are other ways not shown here that may be used to turn on the circuit.

FIG. 8 set forth a view in elevation of the cell phone that could be used to successfully turn on the circuit of the machine or device lock enclosure. A remote control is also shown which also could be used to turn on the circuit of the machine or device lock enclosure.

### DETAILED DESCRIPTION OF THE INVENTION

The drawings and description contained are for purposes of illustrating the invention only and not for purposes of limiting same.

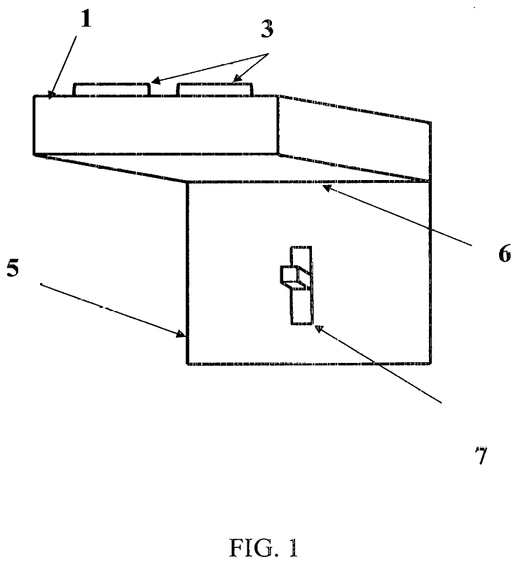

FIG. 1 displays the perspective view of the machine or device lock enclosure integrated into a voting machine or device or any other machine or device. Number 1 indicates the machine or device lock enclosure of the voting machine or device 5 or other machine or device that the machine or device lock enclosures would be built into. Number 3 indicates the housing for the lock. Number 6 indicates where the hinge(s) would be placed. Number 7 indicates the switch that will actuate the circuit within once the two locks are opened.

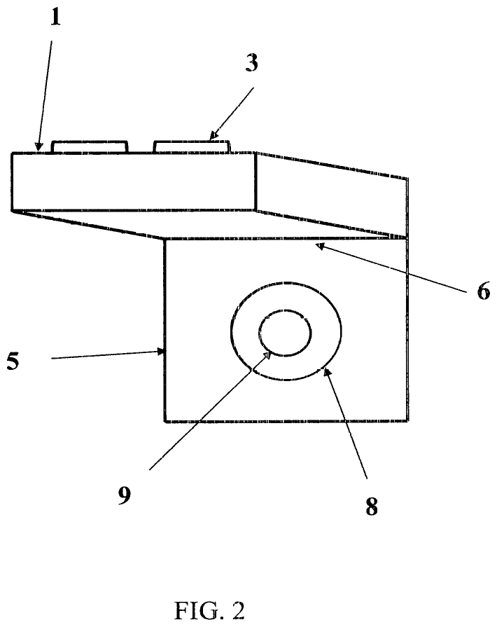

FIG. 2 displays the perspective view of the machine or device lock enclosure integrated into a voting machine or device or any other machine or device. Number 1 indicates the machine or device lock enclosure of the voting machine or device 5 or other machine or device that the machine or device lock enclosures would be built into. Number 3 indicates the housing for the lock. Number 6 indicates where the hinge(s) would be placed. Number 8 indicates the housing for the button. Number 9 indicates the button that will actuate the circuit within once the two locks are opened.

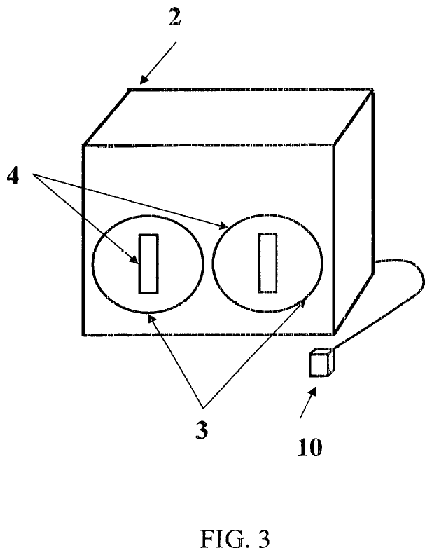

FIG. 3 displays the perspective view of the machine or device lock enclosure that is a separate component 2 that can be connected by connector 10 to a separate voting machine or device or other machine or device. Number 3 indicates the housing for the lock. Number 4 indicates the key slots for the mechanical keys that will actuate the circuit within.

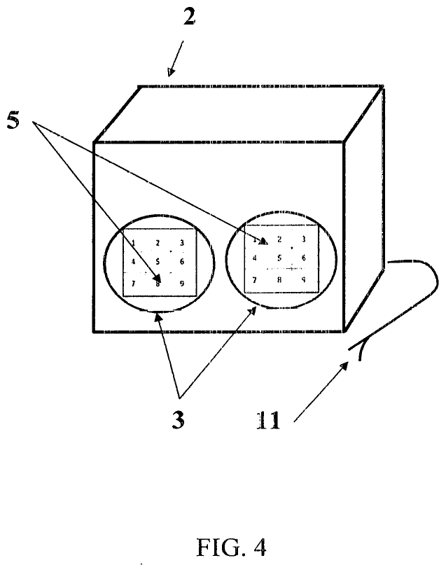

FIG. 4 displays the perspective view of the machine or device lock enclosure that is a separate component 2 that can be connected by hard wire 11 to a separate voting machine or device or other machine or device. No 3 indicates the housing for the numeric keypad. Number 5 indicates the numeric keypads that will actuate the circuit within.

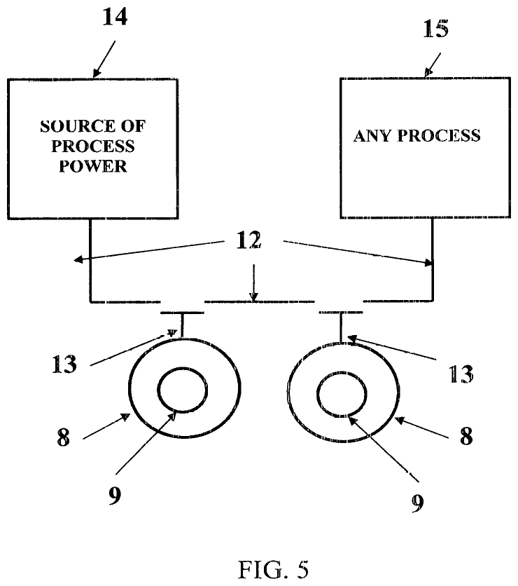

FIG. 5 displays the schematic of the machine or device lock enclosure. Number 8 indicates the housing for the buttons. Number 9 indicates the buttons (shown here with two buttons, but there can be one or any number of buttons) that will actuate the circuit within. Number 13 indicates both of the contacts, switches, solenoids, or any other connections that are activated by the buttons or by any other manner, that will complete the series circuit that will turn on or complete any circuit(s) in the voting machine or device or any other machine or device. Number 12 is the series circuit connected across any process in the voting machine or device or other machine or device. Number 14 is the source of the process power in the machine or device that you want to connect across this circuit. Number 15 is the termination of any process of the series circuit in the machine or device that you want to connect in a circuit.

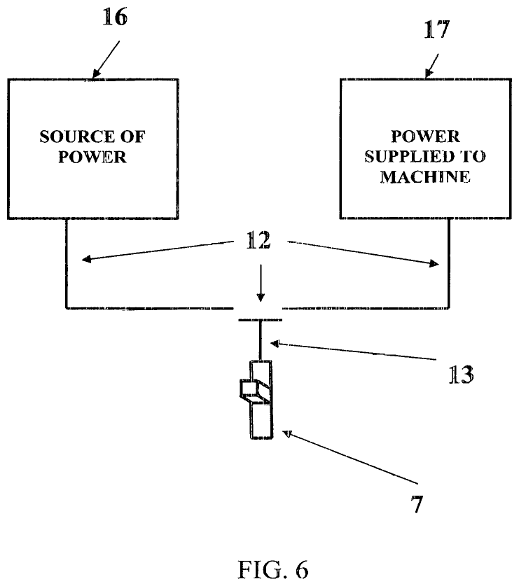

FIG. 6 displays the schematic of the machine or device lock enclosure. Number 7 indicates the switch (shown her with one switch, but there may be any number of switches) that will actuate the circuit within. Number 13 indicates the contact, switch, solenoid, or any other connections that are activated by the buttons or by any other manner, that will complete the series circuit that turn on or complete any circuit(s) in the voting machine or device or any other machine or device. Number 12 is the series circuit connected across any process in the voting machine or device or other machine or device. Number 16 is any process in the machine or device that you want to connect across this circuit but in this case, it is shown as the source of power. Number 17 is the termination of the series circuit of any process of the series circuit in the machine or device that you want to connect across this circuit but in this case as shown as the power supplied to machine or device.

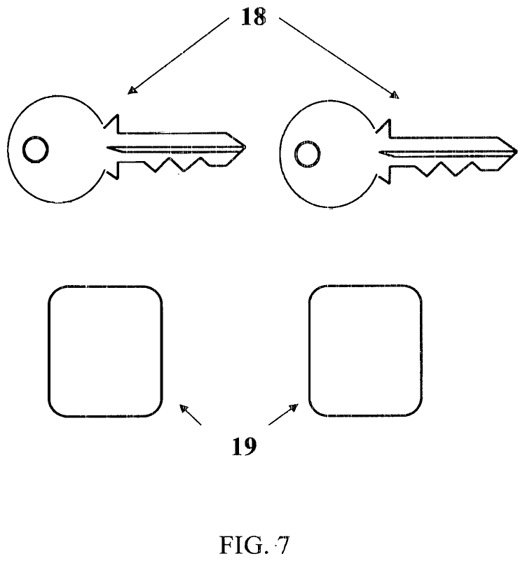

FIG. 7 Number 18 shows the two mechanical keys that can open the enclosure to allow someone to actuate the circuit. Number 19 shows the two cards that can open the enclosure to allow someone to actuate the circuit. Any other method not shown here of actuating and completing the series switches is also acceptable.

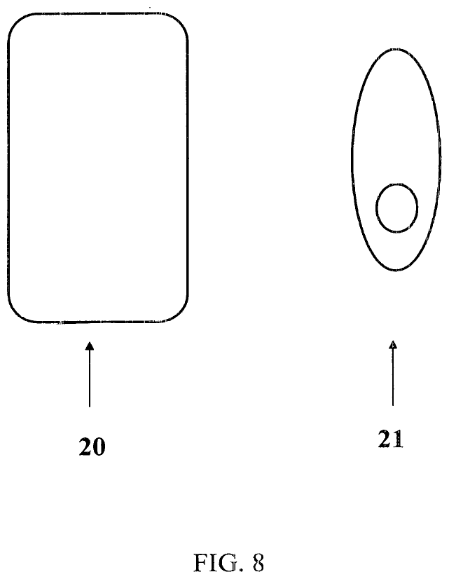

FIG. 8 Number 20 shows a cell phone(s) that can open the enclosure to allow someone to actuate the circuit. Number 21 shows a remote control(s) that can open the enclosure to allow someone to actuate the circuit. Any other method not shown here of actuating and completing the series switches is also acceptable.

What is claimed is:

1. A machine or device lock enclosure component comprising of an integrated and/or separate component that prevents operation of any machine or device, including but not limited to any voting machine or device or any machine or device associated with the voting process, unless unlocked by any two or more different means, including but not limited to two or more mechanical keys, two or more keypads, two or more combination locks, two or more cards that can be read by a card reader (including but not limited to magnetic and all other types), two or more cell phones, two or more remote controls (including but not limited to electromagnetic, radio waves, sound waves, infrared waves or any other type of wave), optical reader (any type including but not limited to optical readers and bar code readers)s, or by any combination or by any other method, that will unlock an electronic circuit by providing electric continuity by any means, including but not limited to contacts, switches or by any mechanical means, electrical means, or by waves (electromagnetic, radio waves, sound waves, infrared waves or any other type of wave), optical reader (any type including but not limited to optical readers and bar code readers), or a combination of these methods, including but not limited to a solenoid (including magnetic), electronic switch (fet: field effect transistor, for example), waves (including but not limited to radio waves, sound waves, infrared waves or any other type of wave),optical reader (any type including but not limited to optical readers and bar code readers), or by any means that will open both locks to complete or provide electric continuity to the same series circuit or different circuits in two or more places, thereby completing the circuit(s) when both locks are activated that will allow the machine or device to turn on and/or allow any of the specific functions on the machine or device to work.

2. A machine or device lock enclosure component according to claim 1, wherein the machine or device lock enclosures can contained in a separate unit which can be connected by any means, but not limited to hard wired, connected with any type of connector into the machine or device, optically read, transmitted to the machine or device from, but not limited to cell phone or remote control, or be built into the machine or device and can be connected by any means, but not limited to, by hard wire, connector or transmitted to other parts of the machine or device.

3. A machine or device lock enclosure component according to claim 1, wherein there can be two or more locks in the component and two or more contacts in the circuit.

4. A machine or device lock enclosure component according to claim 1, wherein the machine or device lock enclosures can be opened by any means, but not limited to, mechanical keys, keypads, combination locks, cards in a card reader (including but not limited to magnetic and all other types), cell phones, remote controls (including but not limited to electromagnetic, radio waves, sound waves, infrared waves or any type of wave), optical reader (any type including but not limited to optical readers and bar code readers), or can be opened by any other manner.

5. A machine or device lock enclosure component according to claim 1, wherein the contacts can be any type of contact providing electrical continuity, including but not limited to contacts, switches or by any mechanical means, electrical means, or by waves (electromagnetic, radio waves, sound waves, infrared waves or any other type of wave), optical reader (any type including but not limited to optical readers and bar code readers), or any combination of these methods, or by any other method, including but not limited to a solenoid (including magnetic), electronic switch (fet: field effect transistor, for example), waves (including but not limited to radio waves, sound waves, infrared waves or any other type of wave), optical reader (any type including but not limited to optical readers and bar code readers)s, or by any means that will open both locks to complete or provide electric continuity.

6. A machine or device lock enclosure component according to claim 1, where the circuit can be any series circuit or any other circuit in any machine or device.

7. A machine or device lock enclosure component according to claim 1, where the circuit turned on by actuating both of the locks can be any process in any machine or device, including but not limited to higher level process or supplying power to the machine or device.
